(19) United States
(12) Patent Application Publication
(10) Pub. No.: US 2020/0412876 A1
(43) Pub. Date: Dec. 31, 2020

(54) ROUTING OF COMMUNICATION SESSIONS WHEN A CONTACT CENTER QUEUE BECOMES OVERLOADED

(71) Applicant: Avaya Inc., Santa Clara, CA (US)

(72) Inventors: Shane O'Neill, Galway (IE); David McGlynn, Galway (IE); Ian Finnerty, Galway (IE)

(21) Appl. No.: 16/457,391

(22) Filed: Jun. 28, 2019

(51) Int. Cl. H04M 3/523; H04M 3/51

(52) U.S. Cl. CPC H04M 3/5234; H04M 3/5237; H04M 3/5175; H04M 3/5238

(57) ABSTRACT

A contact center queue is monitored to determine if the contact center queue meets an overload condition. For example, the contact center queue may be considered to be overloaded when there are ten voice calls on hold in the contact center queue . The contact center queue holds communication sessions in a first communication media (e.g., voice calls). In response to the first contact center queue meeting the first overload condition, a reserve agent group is identified that is associated with the contact center queue. The reserve agent group normally supports communication sessions in a second communication media (e.g., email). A communication session held in the first contact center queue in the first communication media is routed to a contact center resource (e.g., a contact center agent or contact center application) of the first reserve agent group.

### FIELD

The disclosure relates generally to contact centers and particularly to routing of communication sessions in a contact center when a contact center queue becomes overloaded.

### BACKGROUND

It has been found that contact centers are typically more efficient when there are specific groups of contact center agents dedicated to handling communication sessions in a specific communication media type. For example, a contact center may dedicate a first group of contact center agents to only handle emails for a particular product and a second group of contact center agents to only handle voice calls for the product. Under normal conditions, this process works well. However, when a contact center queue that handles a specific communication media becomes overloaded, current processes take the best available resources (e.g., contact center agents) and direct them to the overloaded contact center queue/routing service. While this type of allocation of resources addresses the overload situation, it typically results less efficiency in handling the other communication media types. What is needed is a more efficient way of handling an overload condition while keeping contact center resources dedicated to a specific communication media.

### SUMMARY

These and other needs are addressed by the various embodiments and configurations of the present disclosure. A contact center queue is monitored to determine if the contact center queue meets an overload condition. For example, the contact center queue may be considered to be overloaded when there are ten voice calls on hold in the contact center queue. The contact center queue holds communication sessions in a first communication media (e.g., voice calls). In response to the first contact center queue meeting the first overload condition, a reserve agent group is identified that is associated with the contact center queue. The reserve agent group normally supports communication sessions in a second communication media (e.g., email). A communication session held in the first contact center queue in the first communication media is routed to a contact center resource (e.g., a contact center agent or contact center application) of the first reserve agent group.

The phrases “at least one”, “one or more”, “or”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C”, “A, B, and/or C”, and “A, B, or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material”.

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Any combination of one or more computer readable medium(s) may be utilized. The computer readable medium may be a computer readable signal medium or a computer readable storage medium.

A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

The terms “determine”, “calculate” and “compute,” and variations thereof, as used herein, are used interchangeably and include any type of methodology, process, mathematical operation or technique.

As described herein and in the claims, the term “communication media” is an electronic communication media that conveys information between at least one user (e.g., a person) and a communication resource (e.g., a contact center agent). A communication media may include voice, video, text messaging, chat, Instant Messaging (IM), email, social media, virtual reality, multi-media, and/or the like. The communication media is what is actually conveyed between the user/resource. The communication media does not include the protocols (e.g., Session Initiation Protocol (SIP), video protocols, email protocols, Internet Protocol (IP), and/or the like) used to transport the communication media between communication endpoints/agent terminals/contact center applications.

The term “means” as used herein shall be given its broadest possible interpretation in accordance with 35 U.S.C., Section 112(f) and/or Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

The preceding is a simplified summary to provide an understanding of some aspects of the disclosure. This summary is neither an extensive nor exhaustive overview of the disclosure and its various embodiments. It is intended neither to identify key or critical elements of the disclosure nor to delineate the scope of the disclosure but to present selected concepts of the disclosure in a simplified form as an introduction to the more detailed description presented below. As will be appreciated, other embodiments of the disclosure are possible utilizing, alone or in combination, one or more of the features set forth above or described in detail below. Also, while the disclosure is presented in terms of exemplary embodiments, it should be appreciated that individual aspects of the disclosure can be separately claimed.

### BRIEF DESCRIPTION OF THE DRAWINGS

FIG. 1 is a block diagram of a first illustrative system for managing a contact center queue in a contact center.

FIG. 2 is a first illustrative diagram of how agent groups are defined for managing contact center queues with a reserve agent group.

FIG. 3 is a second illustrative diagram of how agent groups are defined for managing contact center queues with a hybrid agent group and a reserve agent group.

FIG. 4 is a diagram that shows a one-to-one relationship between a contact center queue and a reserve agent group when an overload condition occurs.

FIG. 5 is a diagram that shows a one-to-many relationship between a contact center queue and multiple reserve agent groups when an overload condition occurs.

FIG. 6 is a diagram that shows a many-to-one relationship between multiple contact center queues and a reserve agent group when an overload condition occurs.

FIG. 7 is a flow diagram of a process for managing a contact center queue using a reserve agent group.

FIG. 8 is a flow diagram of a process for managing a contact center queue using a hybrid agent group.

FIG. 9 is a flow diagram of a process for managing a contact center queue that supports multiple communication media types and multiple reserve agent groups.

### DETAILED DESCRIPTION

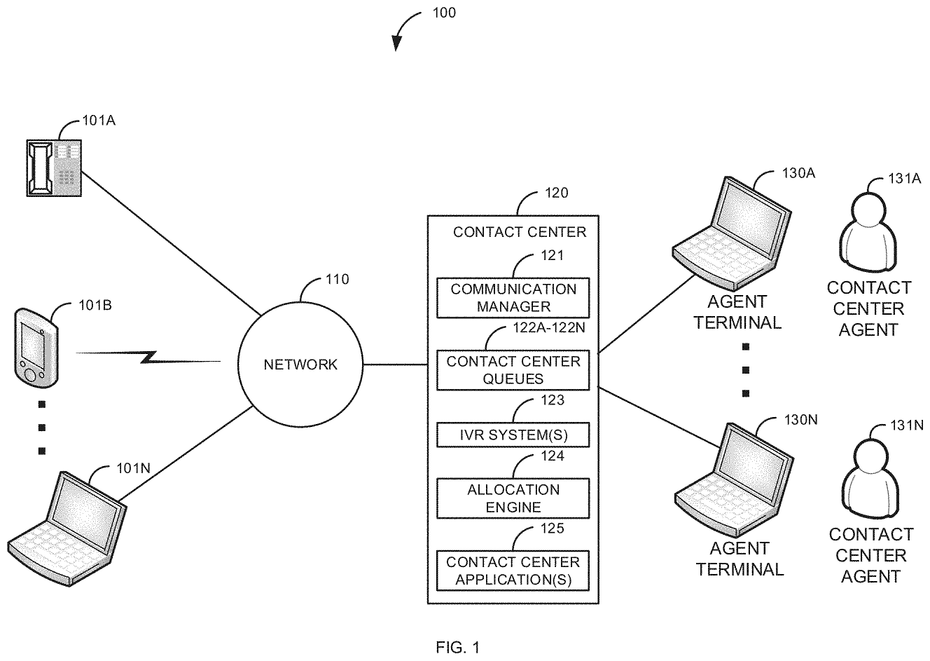

FIG. 1 is a block diagram of a first illustrative system 100 for managing a contact center queue 122 in a contact center 120. The first illustrative system 100 comprises communication endpoints 101A-101N, a contact center 120, and agent terminals 130A-130N. In addition, FIG. 1 also shows contact center agents 131A-131N.

The communication endpoints 101A-101N can be or may include any communication endpoint device that can communicate on the network 110, such as a Personal Computer (PC), a telephone, a video system, a cellular telephone, a Personal Digital Assistant (PDA), a tablet device, a notebook device, a smartphone, and/or the like. The communication endpoints 101A-101N are devices where a communication sessions ends. The communication endpoints 101A-101N are not network elements that facilitate and/or relay a communication session in the network 110, such as a communication manager or router. As shown in FIG. 1, any number of communication endpoints 101A-101N may be connected to the network 110.

The network 110 can be or may include any collection of communication equipment that can send and receive electronic communications, such as the Internet, a Wide Area Network (WAN), a Local Area Network (LAN), a Voice over IP Network (VoIP), the Public Switched Telephone Network (PSTN), a packet switched network, a circuit switched network, a cellular network, a combination of these, and the like. The network 110 can use a variety of electronic protocols, such as Ethernet, Internet Protocol (IP), Session Initiation Protocol (SIP), Integrated Services Digital Network (ISDN), and/or the like. Thus, the network 110 is an electronic communication network configured to carry messages via packets and/or circuit switched communications.

The contact center 120 can be or may include any hardware coupled with software that can manage/route communication sessions. The communication sessions may be voice, video, email, text messaging, chat, Instant Messaging (IM), virtual reality, multimedia, social media, and/or the like. The contact center 120 further comprises a communication manager 121, contact center queues 122A-122N, IVR system(s) 123, an allocation engine 124, and contact center application(s) 125.

The communication manager 121 can be or may include any hardware coupled with software that can route communication sessions, such as, a Private Branch Exchange (PBX), a session manager, a proxy server, a central office switch, a router, and/or the like. The communication manager 121 can manage communication sessions between the communication endpoints 101A-101N, the agent terminals 130A-130N, the IVR system(s) 123, the contact center application(s) 125, and/or the like. The communication manager 121 is a type of routing service that routes communication sessions to the best available resource (e.g., a contact center agent, contact center queue 122, etc.) in the contact center 120.

The contact center queues 122A-122N can be or may include any computer construct for holding communication sessions. As described herein, a contact center queue 122 may include the concept of a contact center pool where communication sessions are placed in a group and where contact center agents 131 may select an individual communication from the group. The contact center queues 122A-122N may hold communication sessions of one or more communication media types. For example, an individual contact center queue 122 may hold both voice and email communication sessions as received on a first-in-first-out basis. The contact center queues 122A-122N may support a specific type of product, service, skillset, and/or the like. The contact center queues 122A-122N may be defined using various attributes, such as, based on language, product type, and/or the like.

The IVR system(s) 123 can be or may include any hardware coupled with software that can interact with a user. The IVR system(s) 123 may include a voice, a video, and/or a text IVR system 123. The IVR system(s) 123 may be used to route communication sessions to the contact center queues 122A-122N.

The allocation engine 124 can be or may include any hardware coupled with software that can allocate contact center resources (e.g., the contact center agents 131A-131N, the IVR system(s) 123, the contact center application(s) 125, and/or the like) to communication sessions in the contact center 120. The allocation engine 124 may be used by an administrator to setup various types of groups of contact center resources that are used to manage communication sessions. For example, an administrator may define groups of contact center agents 131 that are associated with a skill set, a contact center queue 122, a service, a product, a media type, a reserve agent group of contact center agents 131, a hybrid group of contact center agents 131, and/or the like.

The contact center application(s) 125 can be or may include any contact center application 125, such as, a Back-to-Back User Agent (B2BUA), a recording application, a voicemail system, an email bot, a chat bot, a virtual reality bot, and/or the like.

The agent terminals 130A-130N can be a communication endpoint 101. A contact center agent 131 may have more than one agent terminal 130. For example, a contact center agent 131 may have a personal computer and a telephone.

The contact center agents 131A-131N are human agents that handle communication sessions with the communication endpoints 101A-101N.

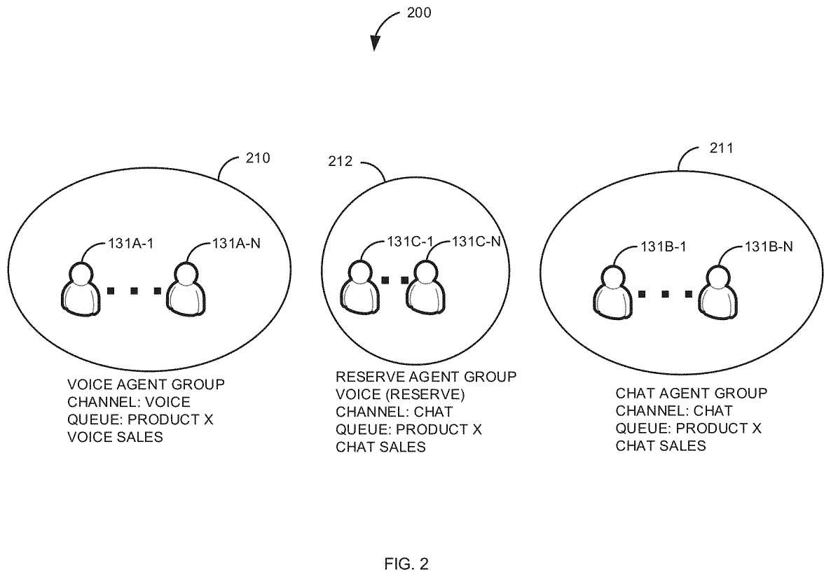

FIG. 2 is a first illustrative diagram 200 of how agent groups 210-212 are defined for managing contact center queues 122A-122N with a reserve agent group 212. The first illustrative diagram 200 comprises a voice agent group 210, a chat agent group 211, and a reserve agent group 212. The agent groups 210-212 are typically defined by an administrator of the contact center 120. In this illustrative example, there are two contact center queues 122A and 122N that are used by the agent groups 210-212. The contact center queue 122A only supports voice communication sessions for Product X sales and the contact center 122N only supports chat communication sessions for Product X sales. While the agent groups 210-212 are described as using contact center agents 131, the agent groups 210-212 may be defined to include any contact center resource, such as, a contact center agent 131, an IVR system 123, a contact center application 125, and/or the like.

The voice agent group 210 comprises contact center agents 131A-1 to 131A-N. The voice agent group 210 supports only voice communication sessions that are being held in a contact center queue 122A. For example, the contact center agents 131A-1 to 131A-N in the voice agent group 210 only support incoming voice calls received from the communication endpoints 101A-101N that are associated with Product X sales.

The chat agent group 211 comprises contact center agents 131B-1 to 131B-N. The chat agent group 211 supports only chat communication sessions that are being held in the contact center queue 122N. For example, the contact center agents 131B-1 to 131B-N in the chat agent group 211 only support incoming chat sessions associated with Product X sales that are being held in the contact center queue 122N.

The reserve agent group 212 comprises contact center agents 131C-1 to 131C-N. The contact center agents 131C-1 to 131C-N in the reserve agent group 212, under regular conditions, only support chat communication sessions in the contact center queue 122N. However, the contact center agents 131C-1 to 131C-N in the reserve agent group 212, when the contact center queue 122A becomes overloaded, switch to supporting voice communication sessions that are being held in the contact center queue 122A. An overload condition may be where a current average wait time exceeds a threshold, a current projected wait time exceeds a threshold, an estimated wait time exceeds a threshold, a specific number of voice communication sessions are being held in the contact center queue 122A (a threshold), and/or the like.

In this example, the reserve agent group 212 is configured to give voice communication sessions priority over chat communication sessions because voice calls are real-time communication sessions versus chat communication sessions that are semi-real-time communication sessions. When the overload condition occurs in the contact center queue 122A, the allocation engine 124 can move all the contact center agents 131C-1 to 131C-N associated with the reserve agent group 212 to support voice communication sessions being held in the contact center queue 122A. This is typically done after each individual contact center agent 131C-1 to 131C-N has completed their current chat communication session. Alternatively, the contact center agents 131C-1 to 131C-N may handle communication sessions in parallel. For example, a contact center agent 131 may handle a voice communication session during an overload condition and still be actively working on chat communication session. In a similar manner, when the overload condition ends, the contact center agents 131C-1 to 131C-N are all moved back to support chat communication sessions in the contact center queue 122N when they have completed their current voice communication sessions.

Alternatively, individual contact center agents (e.g., 130C-1) may be moved to support voice communications in the contact center queue 122A. In this embodiment, there may be a series of thresholds where individual contact center agents 130C-1 to 131C-N are moved one at a time to support voice communications in the contact center queue 122A. For example, the contact center agent 131C-1 is first moved to support voice communication sessions based on an average wait time of five minutes. A second contact center agent 131C-2 is moved over to support voice communications session based on an average wait time of five minutes and fifteen second (e.g., based on fifteen second intervals). As the average wait time increases, based on the fifteen second intervals, additional contact center agents 131C-3 to 131C-N are moved to support voice communication sessions. In a similar manner, as the average wait time decreases, the contact center agents 131C-1 to 131C-N are moved back to support chat communication sessions in the contact center queue 122N.

In FIG. 2, the reserve agent group 212 is shown as primarily supporting chat communication sessions and voice communication sessions in reserve. However, in another embodiment, the reserve agent group 212 may primarily support more than one communication media type. For example, the reserve group 212 may primarily support both chat and email while providing a reserve for voice communication sessions. When the overload condition occurs, the reserve agent group 212 (or specific contact center resources of the reserve agent group 212 based on a level of the overload) only supports voice communication sessions in the overload condition.

In another embodiment, the reserve agent group's 212 role may change based on the overload condition (i.e., based on one or more defined rules). For example, the reserve agent group's 212 role may change during the overload condition to only support chat communication sessions when supporting voice communication sessions for the overload condition (i.e., no longer supporting email communication during the overload condition).

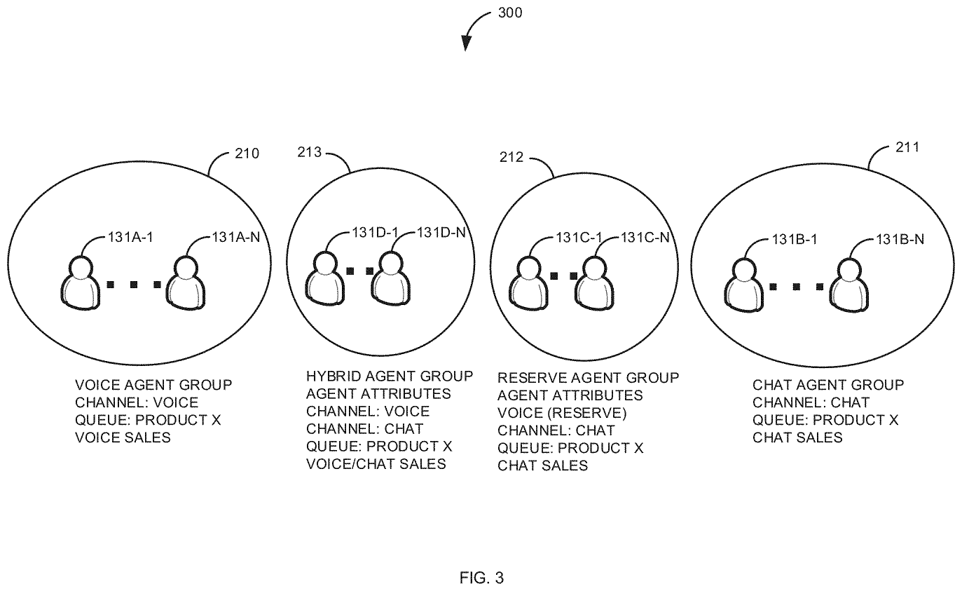

FIG. 3 is a second illustrative diagram 300 of how agent groups 210-213 are defined for managing contact center queues 122A-122N with a hybrid agent group 213 and a reserve agent group 212. The second illustrative diagram 300 comprises the voice agent group 210, the chat agent group 211, the reserve agent group 212, and the hybrid agent group 213. The agent groups 210-213 are typically defined by an administrator of the contact center 120. In this illustrative example, there are two contact center queues 122A and 122N that are used by the agent groups 210-213. The contact center queue 122A only supports voice communication sessions for Product X sales and the contact center 122N only supports chat communication session for Product X sales. While the agent groups 210-213 are described as using contact center agents 131, the agent groups 210-213 may be defined to include any contact center resource, such as, a contact center agent 131, an IVR system 123, a contact center application 125, and/or the like.

The voice agent group 210 comprises contact center agents 131A-1 to 131A-N. The voice agent group 210 supports only voice communication sessions that are being held in a contact center queue 122A. The chat agent group 211 comprises contact center agents 131B-1 to 131B-N. The chat agent group 211 supports only chat communication sessions that are being held in a contact center queue 122N.

The hybrid agent group 213 comprises contact center agents 131D-1 to 131D-N. The contact center agents 131D-1 to 131D-N are agents that are administered to support both the voice communication sessions being held in the contact center queue 122A and the chat communication sessions being held in the contact center queue 122N. Depending upon which contact center queue (122A or 122N) is more loaded, the contact center agents 131D-1 to 131D-N in the hybrid group 213 move between the contact center queues 122A and 122N. The hybrid group 213 is typically an un-reserved pool of contact center resources (e.g., contact center agents 131) that are active on multiple communication media types at a time during normal conditions.

The reserve agent group 212 comprises contact center agents 131C-1 to 131C-N. The contact center agents 131C-1 to 131C-N in the reserve agent group 212, under regular conditions, only support chat sessions in the contact center queue 122N. However, the contact center agents 131C-1 to 131C-N in the reserve agent group 212, when the contact center queue 122A becomes overloaded, switch to supporting voice communication sessions that are being held in the contact center queue 122A. In this example, the contact center queue 122A becomes overloaded after all the contact center agents 131D-1 to 131D-N in the hybrid agent group 213 have been moved to support voice communication sessions being held in the contact center queue 122A and an overload threshold is met. For example, after all the contact center agents 131D-1 to 131D-N in the hybrid agent group 213 have been moved to support voice communications being held in the contact center queue 122A and an expected wait time of over five minutes is exceeded, one or more of the reserve agents 131C-1 to 31C-N (e.g., as described in FIG. 2), are moved to support voice communication sessions being held in the contact center queue 122A. Likewise, as discussed in FIG. 2, the contact center agents 131C-1 to 131C-N in the reserve agent group 212 may be moved back based on the overload condition going away (e.g., as described in FIG. 2).

The processes described in FIGS. 2-3 are described where the agent groups 210-213 are used for voice/chat communication sessions. However, the processes described in FIGS. 2-3 and described herein can be used for any type/combination of communication sessions.

The processes described in FIGS. 2-3 and described herein may use a form of hysteresis when switching from an overload condition and back. For example, the threshold to switch back may be different from the threshold for the overload condition.

In the processes described in FIGS. 2-3, the hybrid agent group 213/reserve agent group 212 are only reassigned in an overload condition and if the contact center agents 131C-1-131CN/131B-1/131B-N have attributes to handle voice communication sessions for that service. This allows the current communication session to not be interrupted until it is finished. In traditional systems or non-blended systems, voice had primacy and could consume all the resources so that there are none left to handle other types of communication sessions (e.g., chat).

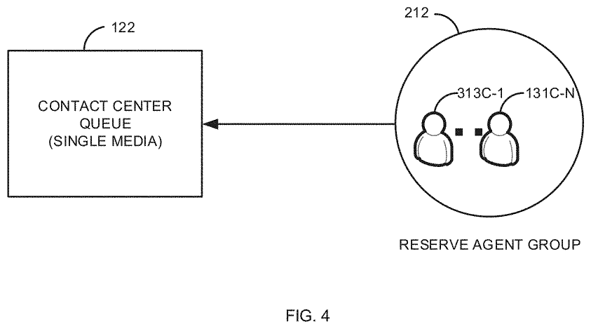

FIG. 4 is a diagram that shows a one-to-one relationship between a contact center queue 122 and a reserve agent group 212 when an overload condition occurs. FIG. 4 shows where a single reserve agent group 212 is assigned to support communication sessions being held in the contact center queue 122. When an overload condition threshold is met, the reserve agent group 212 starts supporting the contact center queue 122 (e.g., as described in FIGS. 2-3).

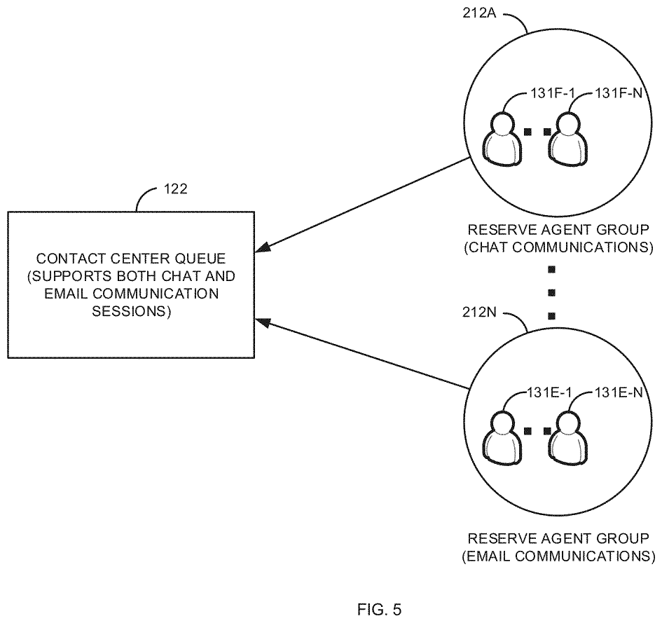

FIG. 5 is a diagram that shows a one-to-many relationship between a contact center queue 122 and multiple reserve agent groups 212A-212N when an overload condition occurs. In FIG. 5, the contact center queue 122 supports multiple communication media types. For illustrative purposes, the contact center queue 122 of FIG. 5 is described as a contact center queue 122 that supports both chat and email communications for technical support for Product Y. When both chat and email communications are received at the contact center 122, the chat and email communication sessions are eventually placed in the contact center queue 122. For example, the chat and email communication sessions are placed in the contact center queue 122 in a first-in-first-out basis. Typically, the reserve agent groups 212A-212N normally support a different communication media (e.g., for the same product/service). However, the reserve agent groups 212A-212N may support the same media type, but are associated with a different skillset (e.g., a different product or service).

In FIG. 5, there are two reserve agent groups 212A-212N that have been defined for handling overload conditions in the contact center queue 122. The reserve agent group 212A is configured to support chat communication sessions during an overload condition in the contact center queue 122. The reserve agent group 212N is configured to support email communication sessions during an overload condition in the contact center queue 122. In one embodiment, both reserve agent groups 212A-212N are brought online when an overload threshold is met.

Alternatively, there may be separate thresholds: 1) for the chat communication sessions, and 2) for the email communication sessions. For example, the chat overload threshold may be where there are ten chat communication sessions currently on hold in the contact center queue 122 and the email overload threshold may be where the oldest email in the contact center queue 122 is over two hours old.

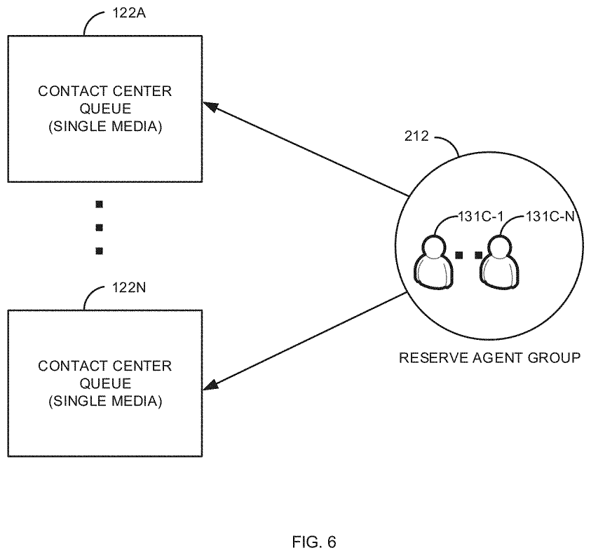

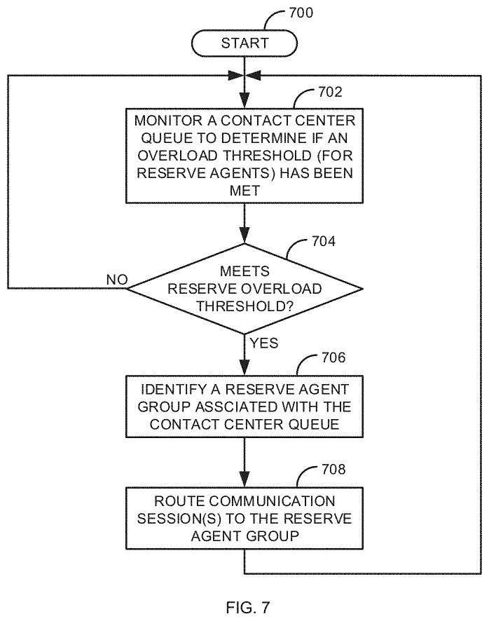

FIG. 6 is a diagram that shows a many-to-one relationship between multiple contact center queues 122 and a reserve agent group 212 when an overload condition occurs. In FIG. 6, the reserve agent group 212 is associated with the contact center queues 122A-122N. When an overload condition occurs in the contact center queue 122A, the contact center agents 131C-1 to 131C-N are assigned to handle the communication sessions of the overloaded contact center queue 122A. Likewise, when the contact center queue 122N becomes overloaded, the contact center agents 131C-1 to 131C-N are assigned to handle communication sessions of the contact center queue 122N. If more than one of the contact center queues 122A-122N becomes overloaded at the same time, the reserve agent group 212 may be divided and/or prioritized based on the needs of the contact center 120. For example, the most overloaded contact center queue 122 may get priority over a lesser overloaded contact center queue 122. If the number of overloaded contact center queues 122A-122N drops back to a single contact center queue (e.g., 122A) and the reserve agent group 212 was divided, then the whole reserve agent group 212 can be applied to handing the overloaded contact center queue 122A. FIG. 7 is a flow diagram of a process for managing a contact center queue 122 using a reserve agent group 212. Illustratively, the communication endpoints 101A-101N, the network 110, the contact center 120, the communication manager 121, the contact center queues 122A-122N, the IVR system(s) 123, the allocation engine 124, the contact center application(s) 125, and the agent terminals 130A-130N are stored-program-controlled entities, such as a computer or microprocessor, which performs the method of FIGS. 7-9 and the processes described herein by executing program instructions stored in a computer readable storage medium, such as a memory (i.e., a computer memory, a hard disk, and/or the like). Although the methods described in FIGS. 7-9 are shown in a specific order, one of skill in the art would recognize that the steps in FIGS. 7-9 may be implemented in different orders and/or be implemented in a multi-threaded environment. Moreover, various steps may be omitted or added based on implementation.

The process starts in step 700. The allocation engine 124 monitors the contact center queue 122 to determine if an overload threshold associated with a reserve agent group 212 has been met. The allocation engine 124 determines in step 704 if the contact center queue 122 meets the reserve overload threshold. If the reserve overload threshold has not been met in step 704, the process goes back to step 702.

Otherwise, if the reserve threshold has been met in step 704, the allocation engine 124 identifies the reserve agent group 212 associated with the contact center queue 122 in step 706. The allocation engine 124 then starts routing communication session(s) to the reserve agent group 212 in step 708 (e.g., as described in FIG. 2). The process then goes back to step 702.

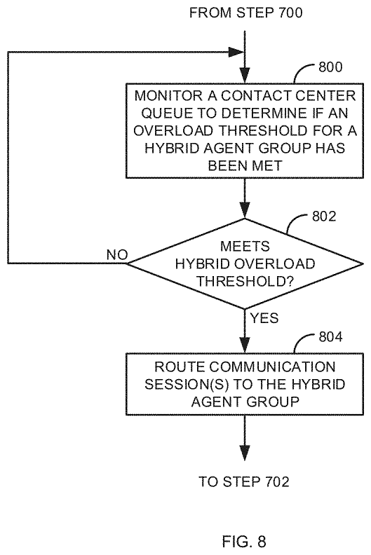

FIG. 8 is a flow diagram of a process for managing a contact center queue 122 using a hybrid agent group 213. The process of FIG. 8 goes between step 700 and step 702 of FIG. 7. After starting in step 700, the allocation engine 124 monitors the contact center queue 122, in step 800, to determine if an overload threshold has been met for the hybrid agent group 213. For example, the overload threshold for the hybrid group 213 may be where more than three video communication sessions have been placed on hold in the contact center queue 122. If the hybrid overload threshold has not been met in step 802, the process goes back to step 800. Otherwise, if the hybrid threshold has been met in step 802, the allocation engine 124 starts routing communication session(s) to members of the hybrid agent group 213 in step 804 (e.g., as described in FIG. 3). The process then goes to step 702.

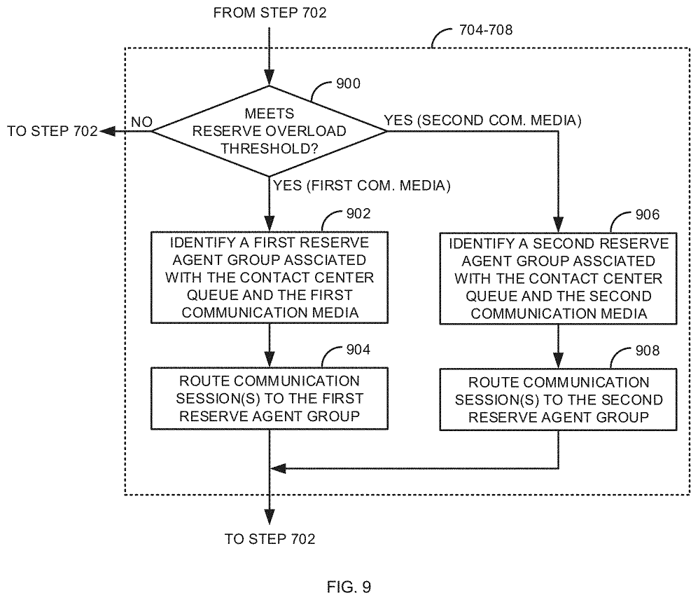

FIG. 9 is a flow diagram of a process for managing a contact center queue 122 that supports multiple communication media types and multiple reserve agent groups 212A-212N. For example, the contact center queue 122 supports video and email communication sessions using the reserve agent groups 212A-212N. In this example, the reserve agent groups 212A-212N are reserve agent groups 212A-212N that normally support communication sessions in other communication media (e.g., text messaging and social media for the same product/service) and/or support other types of services/products. The process of FIG. 9 is an exemplary embodiment of steps 704-708 of FIG. 7. The process of FIG. 9 is described where a contact center queue 122 supports two communication media types, however, the process of FIG. 9 may work for a contact center queue 122 that supports more than two communication media types.

After monitoring the contact center queue 122 in step 702, the allocation engine 124 determines, in step 900, if the reserve overload threshold has been met in step 900. In this illustrative example, the process has two reserve thresholds that can be met because the contact center queue 122 supports two (or more) communication media types.

If the reserve overload threshold for all of the communication media types has not been met in step 900, the process goes back to step 702. Otherwise, if the reserve threshold for the first communication media type (e.g., video) has been met in step 900, the allocation engine 124 identifies, in step 902, the first reserve agent group 212A associated with the contact center queue 122. The allocation engine 124 begins routing, in step 904, the video communication sessions to the first reserve agent group 212A. The process then goes to step 702.

Otherwise, if the reserve threshold for the second communication media type (e.g., email) has been met in step 900, the allocation engine 124 identifies, in step 906, the second reserve agent group 212N associated with the contact center queue 122. The allocation engine 124 begins routing, in step 908, the email communication sessions to the second reserve agent group 212N. The process then goes to step 702.

In one embodiment, both of the yes branches of step 900 may be met at the same time. In this embodiment, steps 902-904 and steps 906-908 may be implemented in parallel (e.g., using separate threads).

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, other industry-equivalent processors, and may perform computational functions using any known or future-developed standard, instruction set, libraries, and/or architecture.

Any of the steps, functions, and operations discussed herein can be performed continuously and automatically.

However, to avoid unnecessarily obscuring the present disclosure, the preceding description omits a number of known structures and devices. This omission is not to be construed as a limitation of the scope of the claimed disclosure. Specific details are set forth to provide an understanding of the present disclosure. It should however be appreciated that the present disclosure may be practiced in a variety of ways beyond the specific detail set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components of the system can be combined in to one or more devices or collocated on a particular node of a distributed network, such as an analog and/or digital telecommunications network, a packet-switch network, or a circuit-switched network. It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the disclosure.

A number of variations and modifications of the disclosure can be used. It would be possible to provide for some features of the disclosure without providing others.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the present disclosure includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the embodiments with reference to particular standards and protocols, the disclosure is not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

The present disclosure, in various embodiments, configurations, and aspects, includes components, methods, processes, systems and/or apparatus substantially as depicted and described herein, including various embodiments, subcombinations, and subsets thereof. Those of skill in the art will understand how to make and use the systems and methods disclosed herein after understanding the present disclosure. The present disclosure, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease and/or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the disclosure.

Moreover, though the description of the disclosure has included description of one or more embodiments, configurations, or aspects and certain variations and modifications, other variations, combinations, and modifications are within the scope of the disclosure, e.g., as may be within the skill and knowledge of those in the art, after understanding the present disclosure. It is intended to obtain rights which include alternative embodiments, configurations, or aspects to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A contact center comprising:
a microprocessor; and
a computer readable medium, coupled with the microprocessor and comprising microprocessor readable and executable instructions that, when executed by the microprocessor, cause the microprocessor to:
monitor a first contact center queue to determine if the first contact center queue meets a first overload threshold, wherein the first contact center queue holds communication sessions in a first communication media; and
in response to determining that the first contact center queue meets the first overload threshold:
identify a first reserve agent group associated with the first contact center queue, wherein the first reserve agent group normally supports communication sessions in a second communication media; and
route a first communication session held in the first contact center queue in the first communication media to a contact center resource of the first reserve agent group.

2. The contact center of claim 1, wherein the first reserve agent group comprises a plurality of contact center agents that only support communication sessions in the second media until the first contact center queue meets the first overload threshold.

3. The contact center of claim 1, wherein the microprocessor readable and executable instructions further cause the microprocessor to:
determine that the first contact center queue meets a second overload threshold; and
in response to the first contact center queue meeting the second overload threshold, route a second communication session held in the first contact center queue in the first communication media to a contact center resource of a hybrid agent group, wherein the second communication session is routed prior to the first communication session and wherein the first communication session is routed in response to all contact center resources in the hybrid group supporting the first communication media.

4. The contact center of claim 1, wherein the first contact center queue supports a second communication media and wherein the microprocessor readable and executable instructions further cause the microprocessor to:
in response to the first contact center queue being overloaded:
identify a second reserve agent group associated with the first contact center queue; and
route a second communication session held in the first contact center queue in the second communication media to a contact center resource of the second reserve agent group.

5. The contact center of claim 4, wherein the microprocessor readable and executable instructions further cause the microprocessor to:
route a third communication session in the first communication media to a hybrid group, wherein the third communication session is routed prior to the first and second communication sessions and wherein the first communication session is routed in response to all contact center resources in the hybrid group supporting the first communication media.

6. The contact center of claim 4, wherein the first overload threshold comprises a threshold for communication sessions held in the first contact center queue for the first communication media and a second overload threshold for communication sessions held in the first contact center queue for the second communication media.

7. The contact center of claim 1, wherein the first reserve agent group is also associated with a second contact center queue.

8. The contact center of claim 1, wherein in response to the first contact center queue meeting the first overload threshold, all contact center resources associated with the first reserve agent group are made available for supporting communication sessions held in the first contact center queue after completing their current communication session in the second communication media.

9. The contact center of claim 1, wherein in response to the first contact center queue meeting the first overload threshold, a first individual contact center resource that becomes available in the first reserve agent group receives the routed first communication session.

10. The contact center of claim 1, wherein the microprocessor readable and executable instructions further cause the microprocessor to:
determine that the first contact center queue is no longer overloaded; and
in response to the first contact center queue no longer being overloaded, stop routing communication sessions in the first communication media to the first reserve agent group.

11. A method comprising:
monitoring, by a microprocessor, a first contact center queue to determine if the first contact center queue meets a first overload threshold, wherein the first contact center queue holds communication sessions in a first communication media; and
in response to the microprocessor determining that the first contact center queue meets the first overload threshold:
identifying, by the microprocessor, a first reserve agent group associated with the first contact center queue, wherein the first reserve agent group normally supports communication sessions in a second communication media; and
routing, by the microprocessor, a first communication session held in the first contact center queue in the first communication media to a contact center resource of the first reserve agent group.

12. The method of claim 11, wherein the first reserve agent group comprises a plurality of contact center agents that only support communication sessions in the second media until the first contact center queue meets the first overload threshold.

13. The method of claim 11, further comprising:
determining that the first contact center queue meets a second overload threshold; and
in response to the first contact center queue meeting the second overload threshold, routing a second communication session held in the first contact center queue in the first communication media to a contact center resource of a hybrid agent group, wherein the second communication session is routed prior to the first communication session and wherein the first communication session is routed in response to all contact center resources in the hybrid group supporting the first communication media.

14. The method of claim 11, wherein the first contact center queue supports a second communication media and further comprising:
in response to the first contact center queue being overloaded:
identifying a second reserve agent group associated with the first contact center queue; and
routing a second communication session held in the first contact center queue in the second communication media to a contact center resource of the second reserve agent group.

15. The method of claim 14, further comprising:
routing a third communication session in the first communication media to a hybrid group, wherein the third communication session is routed prior to the first and second communication sessions and wherein the first communication session is routed in response to all contact center resources in the hybrid group supporting the first communication media.

16. The method of claim 14, wherein the first overload threshold comprises a threshold for communication sessions held in the first contact center queue for the first communication media and a second overload threshold for communication sessions held in the first contact center queue for the second communication media.

17. The method of claim 11, wherein the first reserve agent group is also associated with a second contact center queue.

18. The method of claim 11, wherein in response to the first contact center queue meeting the first overload threshold, all contact center resources associated with the first reserve agent group are made available for supporting communication sessions held in the first contact center queue after completing their current communication session in the second communication media.

19. The method of claim 11, wherein in response to the first contact center queue meeting the first overload threshold, a first individual contact center resource that becomes available in the first reserve agent group receives the routed first communication session.

20. The method of claim 11, wherein the microprocessor readable and executable instructions further cause the microprocessor to:
determine that the first contact center queue is no longer overloaded; and
in response to the first contact center queue no longer being overloaded, stop routing communication sessions in the first communication media to the first reserve agent group.
